(19) United States
(12) Patent Application Publication
(10) Pub. No.: US 2025/0039827 A1
(43) Pub. Date: Jan. 30, 2025

(54) ASSISTED UWB RANGING

(71) Applicant: QUALCOMM INCORPORATED, San Diego, CA (US)

(72) Inventors: Varun Amar REDDY, San Diego, CA (US); Alexandros MANOLAKOS, Athens (GR); Pooria PAKROOH, San Marcos, CA (US); Krishna Kiran MUKKAVILLI, San Diego, CA (US)

(21) Appl. No.: 18/715,280

(22) PCT Filed: Feb. 8, 2023
(86) PCT No.: PCT/US2023/062198

§ 371 Date: May 31, 2024

(30) Foreign Application Priority Data
Mar. 1, 2022 (GR) 20220100188

(51) Int. Cl. H04W 64/00; H04B 1/7163; H04J 3/06; H04W 56/00

(52) U.S. Cl. CPC H04W 64/00; H04B 1/7163; H04J 3/0661; H04W 56/0015

(57) ABSTRACT

An example signal transfer method includes: determining, at a first apparatus, whether to transmit an ultra-wideband physical-layer signal with a first configuration or a second configuration based on an application for transfer of the ultra-wideband physical-layer signal, the first configuration being different from the second configuration; and transmitting, from the first apparatus to a second apparatus, the ultra-wideband physical-layer signal.

[Continued on next page]

### CROSS-REFERENCE TO RELATED APPLICATIONS

This application claims the benefit of Greek patent application Ser. No. 20/220,100188, filed Mar. 1, 2022, entitled “ASSISTED UWB RANGING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Ultra-wideband (UWB) technology may be used to transmit signals with wide bandwidth (e.g., >500 MHZ). Signal energy may be transmitted without interfering with narrowband and carrier wave transmission in the same frequency band. UWB may be used for low-energy, short-range applications, e.g., for ranging. UWB is presently divided into channels 1-15 spanning frequencies from about 3.5 GHz to about 4.5 GHz and from about 6.5 GHz to about 10 GHz.

### SUMMARY

An example apparatus includes: a transceiver configured to transmit and receive ultra-wideband signals; a memory; and a processor, communicatively coupled to the memory and the transceiver, configured to: determine whether to transmit an ultra-wideband physical-layer signal with a first configuration or a second configuration based on an application for transfer of the ultra-wideband physical-layer signal, the first configuration being different from the second configuration; and transmit, via the transceiver, the ultra-wideband physical-layer signal.

An example signal transfer method includes: determining, at a first apparatus, whether to transmit an ultra-wideband physical-layer signal with a first configuration or a second configuration based on an application for transfer of the ultra-wideband physical-layer signal, the first configuration being different from the second configuration; and transmitting, from the first apparatus to a second apparatus, the ultra-wideband physical-layer signal.

Another example apparatus includes: means for determining whether to transmit an ultra-wideband physical-layer signal with a first configuration or a second configuration based on an application for transfer of the ultra-wideband physical-layer signal, the first configuration being different from the second configuration; and means for transmitting the ultra-wideband physical-layer signal.

An example non-transitory, processor-readable storage medium includes processor-readable instructions to cause a processor of an apparatus to: determine whether to transmit an ultra-wideband physical-layer signal with a first configuration or a second configuration based on an application for transfer of the ultra-wideband physical-layer signal, the first configuration being different from the second configuration; and transmit the ultra-wideband physical-layer signal.

An example server includes: a transceiver; a memory; and a processor, communicatively coupled to the memory and the transceiver, configured to: receive, via the transceiver, an indication that a first user equipment is capable of ranging measurements using an ultra-wideband session; and transmit, via the transceiver to the first user equipment, a message indicating a sidelink channel for the first user equipment to use for time and frequency synchronization and an ultra-wideband channel for the first user equipment to use for ranging with a second user equipment.

An example ultra-wideband ranging assistance method includes: receiving an indication that a first user equipment is capable of ranging measurements using an ultra-wideband session; and transmitting, to the first user equipment, a message indicating a sidelink channel for the first user equipment to use for time and frequency synchronization and an ultra-wideband channel for the first user equipment to use for ranging with a second user equipment.

Another example server includes: means for receiving an indication that a first user equipment is capable of ranging measurements using an ultra-wideband session; and means for transmitting, to the first user equipment, a message indicating a sidelink channel for the first user equipment to use for time and frequency synchronization and an ultra-wideband channel for the first user equipment to use for ranging with a second user equipment.

Another example non-transitory, processor-readable storage medium includes processor-readable instructions to cause a processor of a server to: receive an indication that a first user equipment is capable of ranging measurements using an ultra-wideband session; and transmit, to the first user equipment, a message indicating a sidelink channel for the first user equipment to use for time and frequency synchronization and an ultra-wideband channel for the first user equipment to use for ranging with a second user equipment.

Another example apparatus includes: a transceiver configured to transmit and receive ultra-wideband signals; a memory; and a processor, communicatively coupled to the memory and the transceiver, configured to: transmit, via the transceiver, a request for an on-demand non-ultra-wideband signal; receive, via the transceiver, the on-demand non-ultra-wideband signal; perform time synchronization and frequency synchronization using the on-demand non-ultra-wideband signal; and perform ranging using an ultra-wideband physical-layer signal having a corresponding frequency band and an expected timing; where the request for the on-demand non-ultra-wideband signal includes a first indication of a requested frequency of the on-demand non-ultra-wideband signal, where the requested frequency is within a threshold frequency of the frequency band of the ultra-wideband physical-layer signal, or includes a second indication of a requested timing of the on-demand non-ultra-wideband signal, where the requested timing is within a threshold timing of the expected timing of the ultra-wideband physical-layer signal, or includes a combination thereof.

An example ranging method includes: transmitting, from an apparatus, a request for an on-demand non-ultra-wideband signal; receiving, at the apparatus, the on-demand non-ultra-wideband signal; performing, at the apparatus, time synchronization and frequency synchronization using the on-demand non-ultra-wideband signal; and performing, at the apparatus, ranging using an ultra-wideband physical-layer signal having a corresponding frequency band and an expected timing; where the request for the on-demand non-ultra-wideband signal includes a first indication of a requested frequency of the on-demand non-ultra-wideband signal, where the requested frequency is within a threshold frequency of the frequency band of the ultra-wideband physical-layer signal, or includes a second indication of a requested timing of the on-demand non-ultra-wideband signal, where the requested timing is within a threshold timing of the expected timing of the ultra-wideband physical-layer signal, or includes a combination thereof.

Another example apparatus includes: means for transmitting a request for an on-demand non-ultra-wideband signal; means for receiving the on-demand non-ultra-wideband signal; means for performing time synchronization and frequency synchronization using the on-demand non-ultra-wideband signal; and means for performing ranging using an ultra-wideband physical-layer signal having a corresponding frequency band and an expected timing; where the request for the on-demand non-ultra-wideband signal includes a first indication of a requested frequency of the on-demand non-ultra-wideband signal, where the requested frequency is within a threshold frequency of the frequency band of the ultra-wideband physical-layer signal, or includes a second indication of a requested timing of the on-demand non-ultra-wideband signal, where the requested timing is within a threshold timing of the expected timing of the ultra-wideband physical-layer signal, or includes a combination thereof.

Another example non-transitory, processor-readable storage medium includes processor-readable instructions to cause a processor of an apparatus to: transmit a request for an on-demand non-ultra-wideband signal; receive the on-demand non-ultra-wideband signal; perform time synchronization and frequency synchronization using the on-demand non-ultra-wideband signal; and perform ranging using an ultra-wideband physical-layer signal having a corresponding frequency band and an expected timing; where the request for the on-demand non-ultra-wideband signal includes a first indication of a requested frequency of the on-demand non-ultra-wideband signal, where the requested frequency is within a threshold frequency of the frequency band of the ultra-wideband physical-layer signal, or includes a second indication of a requested timing of the on-demand non-ultra-wideband signal, where the requested timing is within a threshold timing of the expected timing of the ultra-wideband physical-layer signal, or includes a combination thereof.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example network entity.

FIG. 7 is a block diagram of an example set of ultra-wideband physical-layer signal configurations.

FIG. 8 is block diagram of protocol stacks.

FIG. 9 is a timing diagram of an out-of-band signal and an ultra-wideband synchronization preamble signal.

FIG. 10 is a timing diagram of an out-of-band signal and multiple transmissions of an ultra-wideband synchronization preamble signal.

FIG. 11 is a timing diagram of an out-of-band signal and an ultra-wideband scrambled timestamp sequence preamble signal.

FIG. 12 is a block diagram of another example set of ultra-wideband physical-layer signal configurations.

FIG. 13 is frequency plot of ultra-wideband channels and out-of-band signals.

FIG. 14 is a timing diagram of an out-of-band signal and an ultra-wideband synchronization preamble signal relative to an ultra-wideband ranging block.

FIG. 15 is a signaling and process flow for ultra-wideband ranging.

FIG. 16 is a block flow diagram of a signal transfer method.

FIG. 17 is a block flow diagram of another ultra-wideband ranging assistance method.

FIG. 18 is a block flow diagram of a ranging method.

### DETAILED DESCRIPTION

Techniques are discussed herein for using Ultra-Wideband (UWB) technology for sensing for channel estimation, and/or for ranging. For example, UWB physical (PHY) layer signals of multiple configurations, e.g., with a synchronization preamble, a scrambled timestamp sequence (STS) preamble, and/or a payload may be transmitted and a user equipment (UE) may toggle between different types of UWB PHY layer signals. The UE may send an explicit or implicit indication of which type of UWB PHY layer signal is being used. As another example, a new set of UWB PHY layer signal configurations may be used compared to a legacy configuration set. Which configuration is being used may be indicated using the same bits used to indicate the legacy configurations. One or more configurations may be common with the legacy set of configurations to provide legacy support. The new set of configurations may include a configuration with a synchronization preamble alone, an STS preamble alone, and/or a customized sequence (e.g., based on a technology used or an application for the UWB PHY layer signal). Which configuration is used may be determined based on an application for the UWB PHY layer signal (e.g., whether the signal is used for sensing or ranging). Other implementations than these examples, however, may be used.

Items and/or techniques described herein may provide one or more of the following capabilities, as well as other capabilities not mentioned. Link budget may be improved, e.g., by directing signal energy into a signal portion for ranging or sensing. Ranging accuracy may be improved, e.g., by directing available signal energy into a signal portion for ranging. Sensing and/or ranging accuracy may be improved, e.g., by using signal configurations customized for each application. Sensing and/or ranging accuracy may be improved, e.g., by requesting and/or providing non-UWB signals for time and/or frequency synchronization where the non-UWB signals overlap or are near in frequency, and are near in time, to a UWB signal to be used for ranging. Sidelink time and frequency synchronization may be leveraged to implement UWB ranging which may enhance ranging accuracy. Establishment of a UWB session may be quickened, e.g., by avoiding a dedicated acquisition and preamble detection phase. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrow band Internet-of-Things (NB-IOT), enhanced mobile broadband (eMBB), or others) that may provide access for different types of devices. In some examples, the term “cell” may refer to a portion of a geographic coverage area (for example, a sector) over which the logical entity operates.

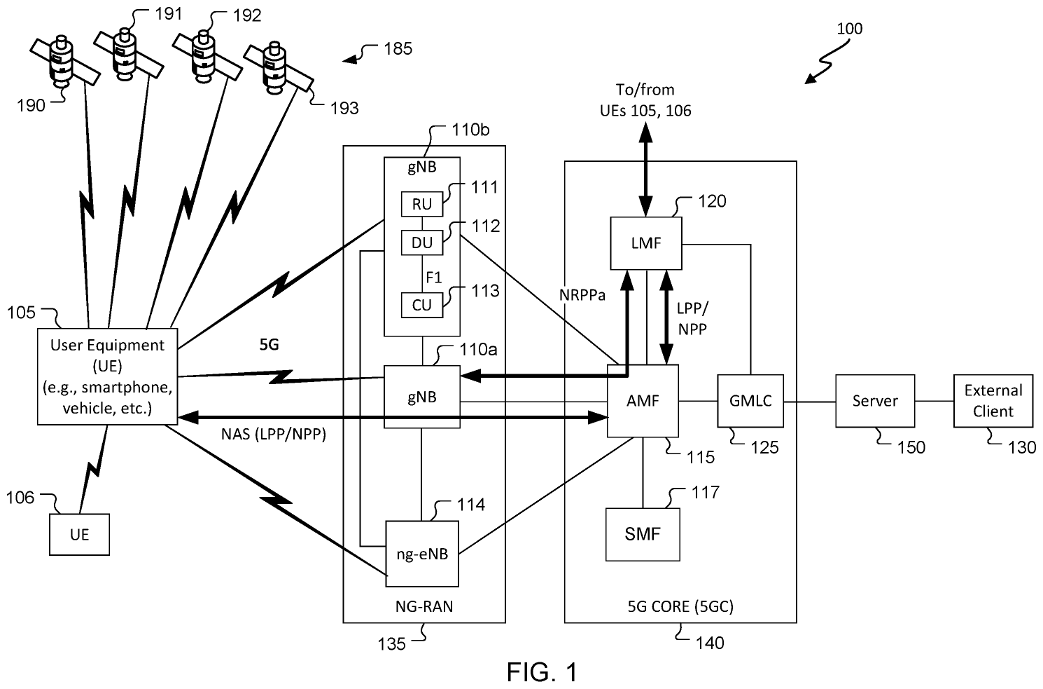

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth R-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. I may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120) may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QOS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a. 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a. 110b or the ng-eNB 114) and/or may be used by the LMF 120 to obtain location related information from the gNBs 110a. 110b and/or the ng-eNB 114, such as parameters defining directional SS (Synchronization Signals) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

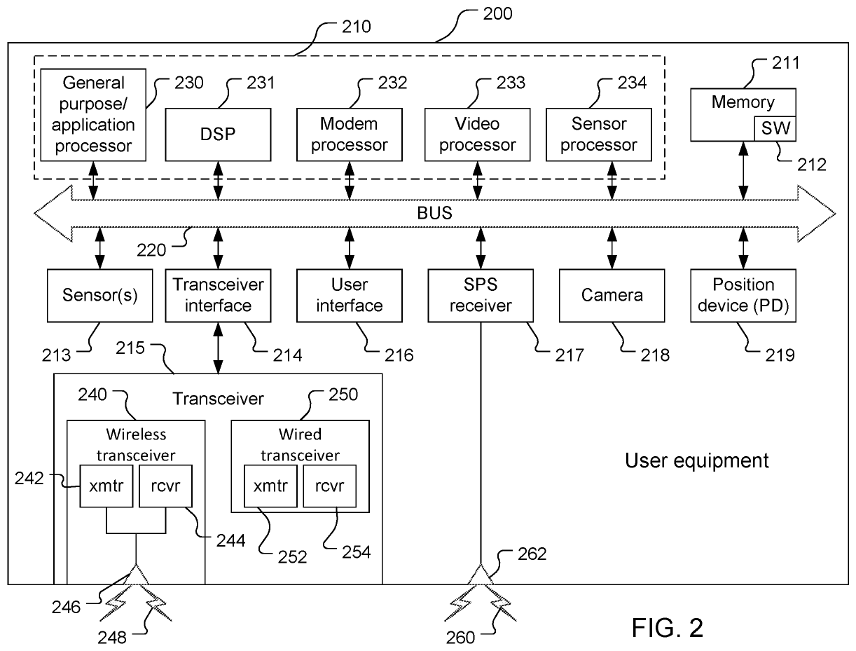

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth R, Zigbee etc. New Radio may use mm-wave frequencies and/or sub-6GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

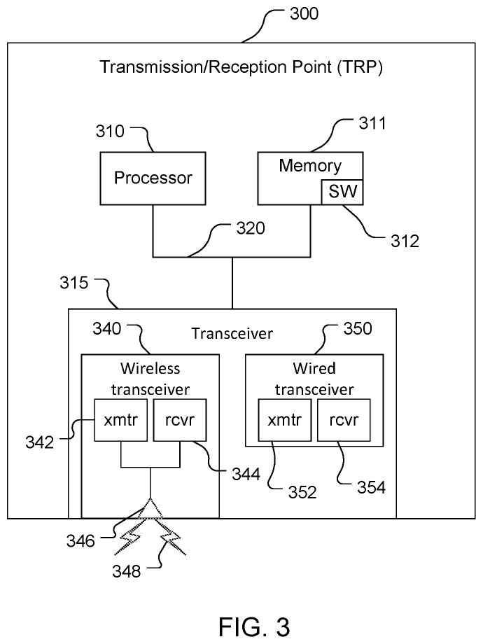

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

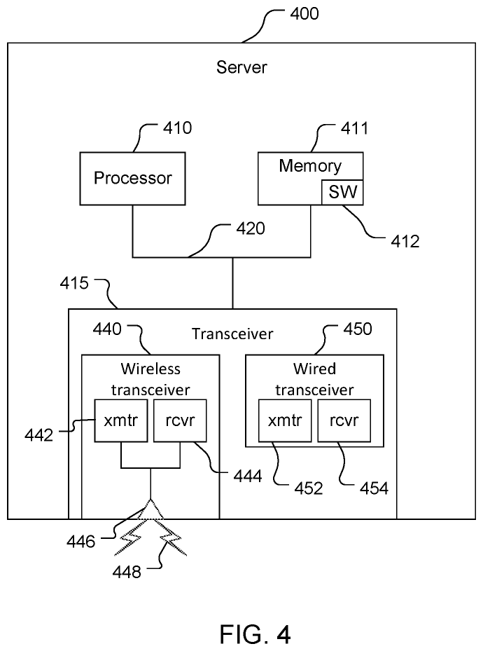

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile

Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AOD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

### Positioning With UWB

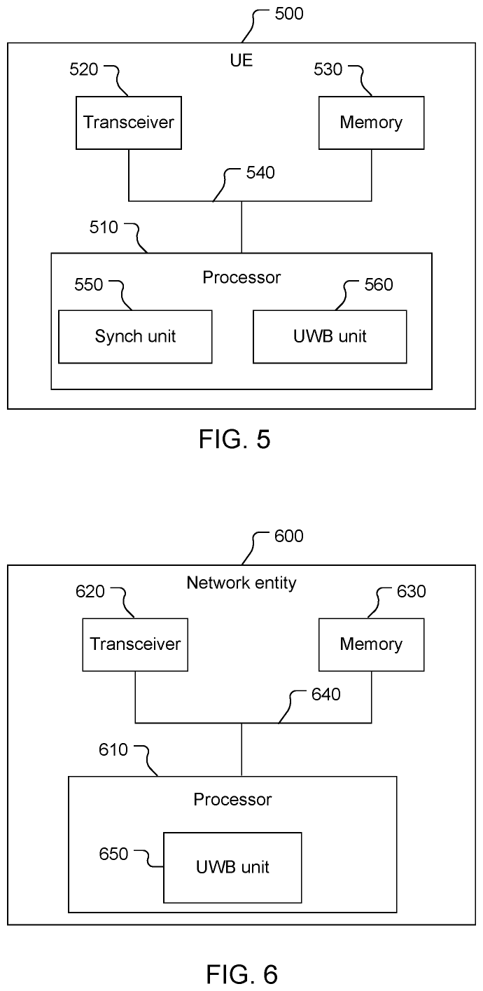

Referring also to FIG. 5, a UE 500 includes a processor 510, a transceiver 520, and a memory 530 communicatively coupled to each other by a bus 540. The UE 500 may include the components shown in FIG. 5. The UE 500 is a wireless communication device and is part of a monitor vehicle (e.g., car, truck, motorcycle, etc.) that is capable of monitoring another vehicle (e.g., analyzing one or more images of a target vehicle to determine and report one or more characteristics of the target vehicle, and/or receiving and reporting one or more messages from another monitor vehicle regarding the target vehicle, etc.). The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a synch unit 550 (a synchronization unit) and a UWB unit 560. The synch unit 550 and the UWB unit 560 are discussed further below; and the description may refer to the processor 510 generally, or the UE 500 generally, as performing any of the functions of the synch unit 550 or the UWB unit 560, with the UE 500 being configured to perform the functions of the synch unit 550 and the UWB unit 560.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) includes a UWB unit 650. The UWB unit 650 is discussed further below, and the description may refer to the processor 610 generally, or the network entity 600 generally, as performing any of the functions of the UWB unit 650. The network entity 600 is configured to perform the functions of the UWB unit 650.

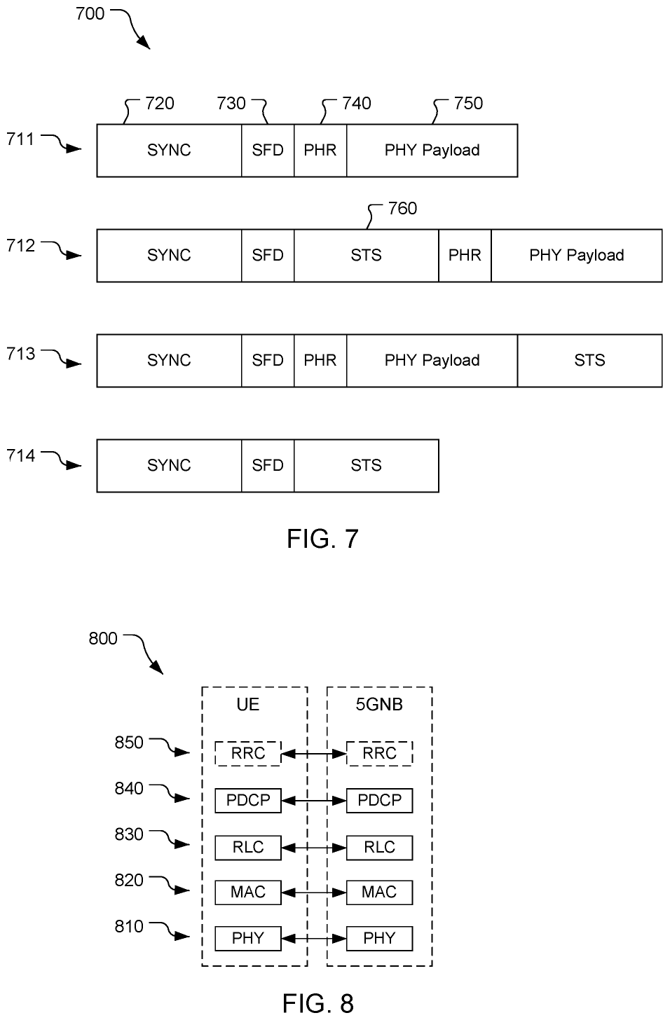

Referring also to FIGS. 7 and 8, the UWB unit 560 may be configured to transmit physical-layer signals (PHY-layer signals) in a variety of configurations. As shown in FIG. 8, a physical layer 810 is a bottom layer of a protocol stack 800, with the protocol stack 800 including a MAC layer 820, an RLC layer 830, a PDCP layer 840, and possibly RRC layer 850. In this example, the protocol stack 800 is a 5G user plane protocol stack (without the RRC layer 850) and a 5G control plane protocol stack with the RRC layer 850, but other protocol stacks may be used, although in each protocol stack the PHY layer 810 would be at the lowest layer and the other layers being higher layers (relative to the PHY layer 810). As shown in FIG. 7, a set 700 of PHY-layer UWB signal frame configurations that the UWB unit 560 is configured to transmit and receive includes a first configuration 711, a second configuration 712, a third configuration 713, and a fourth configuration 714. The configurations 711-714 include respective combinations of a SYNC preamble 720 and an SFD 730 (Start of Frame Delimiter), along with a PHR 740 (PHY header), a PHY payload 750, and/or an STS preamble 760 (Scrambled Timestamp Sequence) as shown. The configurations 711-714 may be referred to as STS packet configurations zero, one, two, and three due to a two-bit field that may be used to identify which of the configurations 711-714 is used, even though the first configuration 711 does not include the STS preamble 760. Ranging functionality is based on channel estimation using the SYNC preamble 720, which presently is an Ipatov ternary sequence that exhibits good autocorrelation. While the autocorrelation properties help with channel estimation, because this preamble sequence is known to the public, the SYNC preamble is susceptible to OTA (over-the-air) attacks that can falsify a ToA estimate. The SFD 730 is a small piece of information (e.g., a single bit) that demarcates an end of the SYNC preamble 720 from the remainder of the frame. The PHY payload 750 comprises data. The STS preamble 760 is a secure sequence generated using a Deterministic Random Bit Generator (DRBG) based on AES-128 counter mode. The STS preamble 760 may be produced by encrypting plaintext into ciphertext, with the plaintext known by the entity transmitting the PHY signal and the entity receiving the PHY signal, e.g., having been exchanged through a secure connection during application layer configuration. The plaintext may be agreed to using OOB (out-of-band) signaling (non-UWB signaling) while ranging may be performed using UWB signaling because accuracy with UWB may be more accurate due to the use of higher bandwidth signals. The STS preamble 760 provides a secure preamble to thwart would-be OTA attacks. While the SYNC preamble 720 may be used to perform channel estimation, the STS preamble 760 is measured to perform secure channel estimation. The SYNC preamble 720 may be used by a receiving entity to perform acquisition (including preamble detection, time synchronization, and frequency synchronization), and the time/frequency synchronization, the SYNC preamble 720, and the STS preamble 760 may be used to perform channel estimation and/or ranging (e.g., determining distance to an entity transmitting the PHY-layer signal). Time synchronization is performed by a receiver to establish a timing reference with respect to a start of a packet, and to determine the start/end of the symbols within the preamble in order to perform channel estimation in a coherent manner, by averaging over channel estimates corresponding to each of the preamble symbols. Additionally, frequency synchronization enables the receiver to track the carrier frequency of the incoming signal to extract the baseband signal information. Accurate frequency synchronization helps prevent an erroneous phase shift across the preamble symbols, which would hamper channel estimation performance.

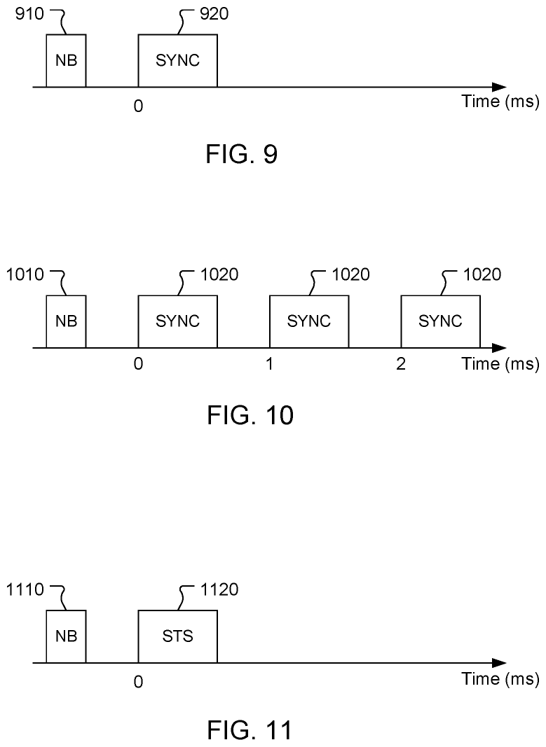

Referring also to FIGS. 9-11, the synch unit 550 of a UE that will transmit a UWB PHY-layer ranging signal may be configured to transmit a narrow band signal to be used for time and frequency synchronization, and the corresponding UWB unit 560 may be configured to transmit a reduced-frame (partial-frame) PHY-layer signal to be used for ranging. The synch unit 550 of a UE (called a responder) that will receive the UWB PHY-layer ranging signal may be configured to use the narrow band signal to perform time and frequency synchronization, and the corresponding UWB unit 560 may be configured to measure the reduced-frame PHY-layer signal for ranging (e.g., to determine ToA, AoA, etc.). For example, as shown in FIG. 9, the initiator UE may transmit an NB signal 910 (narrowband signal) for time and frequency synchronization and transmit a reduced-frame signal 920. Here, the reduced-frame signal 920 is the SYNC preamble 720 only. The NB signal 910 may be sent using any of a variety of technologies, e.g., other IEEE 802.15.4 technologies such as Bluetooth R, Zigbee R, etc. With power in UWB transmissions limited to a maximum power value over 1 ms, by not transmitting the SFD, STS, or payload, power that would be used for these items may be used for the SYNC preamble 720 which is used for UWB ranging. Thus, more power may be used for a signal used for UWB ranging than a signal portion for UWB ranging if a full-frame signal is transmitted and used for time/frequency synchronization and UWB ranging. Also, if the NB signal 910 is not limited by the UWB transmit power constraint, the NB signal 910 may be transmitted with higher transmit power (e.g., up to 20 dB higher) than a UWB signal, improving the link budget for acquisition. With only the SYNC preamble 720 sent, no SFD, STS preamble, or payload is sent, which helps reduce OTA transmissions and improve link budget by combining channel estimates obtained from several SYNC preamble instances (i.e., multiple copies of the SYNC preamble 720 accumulated over time). As shown in FIG. 10, the synch unit 550 of the initiator UE may transmit an NB signal 1010 for time/frequency synchronization and UWB session setup, and the UWB unit 560 may transmit a SYNC preamble 1020 multiple times for use in channel estimation. Using the NB signal 910, 1010 for time/frequency synchronization helps with link budget but may provide less accurate time/frequency synchronization than using a UWB signal, which may lead to less accurate channel estimation and in turn less accurate ranging (and position estimation). Using the SYNC preamble alone for the reduced-frame signal 920, or using the SYNC preamble 1020 alone, for channel estimation may enable OTA attacks. As shown in FIG. 11, the synch unit 550 of the initiator UE may transmit an NB signal 1110 for time/frequency synchronization and UWB session setup, and the UWB unit 560 may transmit an STS preamble 1120 for use in channel estimation and/or ranging, which may help reduce OTA attacks (at least relative to using the SYNC preamble alone).

Techniques are discussed herein for changing (e.g., toggling) between using UWB signaling (e.g., the SYNC preamble) for time/frequency synchronization or using narrow band assistance for time/frequency synchronization, and for changing between transmitting the SYNC preamble for channel estimation and/or ranging or transmitting another signal (e.g., the STS or a custom signal) for channel estimation and/or ranging. For example, the synch unit 550 could toggle between selecting and transmitting one of the configurations 711-714 and selecting and transmitting one of the configurations 711-713 or the SYNC preamble 720 alone. The synch unit 550 could indicate the toggling, e.g., indicate which set of configurations that synch unit 550) is selecting a configuration from, to a recipient of the frame. For example, which configuration from a set of configurations is used may be indicated by a 2-bit field (e.g., as provided in existing IEEE and FiRa (fine ranging consortium) standards) and a toggle indication of one bit may indicate which set of configurations is used (e.g., a 0 indicating a set of configurations containing the configurations 711-714 and a 1 indicating a set of configurations containing the configurations 711-713 and the SYNC preamble 720). A set of configurations may contain one or more configurations. The toggle indication may be provided in an upper-layer message (e.g., in UCI (uplink control information)) or one or more bits in a MAC frame. The toggle information may indicate that assistance will be provided by OOB signaling (not in a UWB signal, although possibly within a frequency range of UWB signaling) for time/frequency synchronization. Also or alternatively, OOB signaling may indicate the absence of a payload in the frame and thus that the UWB frame is provided for ranging functionality only. Changing may occur between a full-frame mode (with frames including the SYNC preamble 720, the SFD 730, and the STS preamble 760) and a partial-frame mode (e.g., with frames containing only the SYNC preamble 720, or frames containing only the STS preamble 760). The synch unit 550 of a UE receiving a UWB frame may read the relevant bits to determine which frame configuration is being sent and thus determine how to interpret a received UWB frame. For toggle information in a MAC frame, one or more reserved bits may be assigned for indicating the toggling. For example, both the IEEE and FiRa have provisions for reserved bits in MAC frames, one or more of which may be used to achieve the toggling indication functionality.

Which frame configuration is being used may be indicated implicitly, e.g., without using any additional bit to indicate a toggling or a frame configuration set. For example, existing information (e.g., one or more already used bits) may indicate explicitly or implicitly whether a UWB frame will include a payload. This existing information may be interpreted to determine whether the UWB frame will include a payload, with presence of a payload meaning, by a transmitting UE (or determined by the synch unit 550 to mean), that the UWB frame is for time/frequency synchronization and ranging and absence of the payload meaning that the UWB frame is for ranging only (e.g., with time/frequency synchronization provided for by an OOB signal). As another example, a UWB frame may not include a payload and this absence of payload implicitly indicates that the UWB frame will be for ranging and/or sensing while an OOB signal will be for time/frequency synchronization.

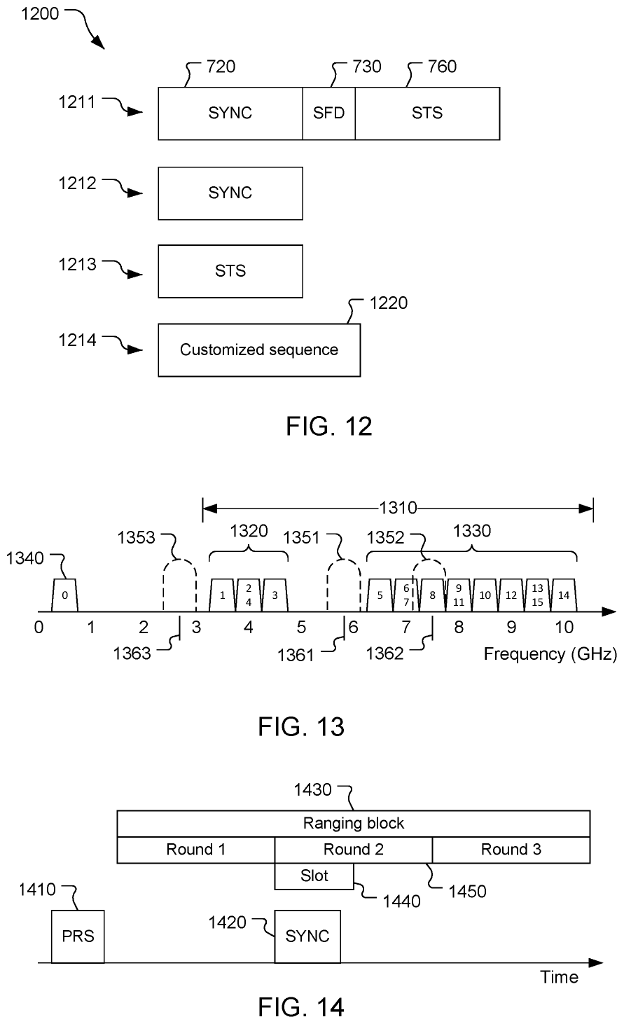

Numerous sets of possible UWB frame configurations may be used instead of the configurations 711-714. For example, existing two bits in either the IEEE or FiRa standards may be reused for selecting a configuration in an alternative configuration set (e.g., a customized configuration set). For example, referring also to FIG. 12, a set 1200 of UWB frame configurations includes a first configuration 1211, a second configuration 1212, a third configuration 1213, and a fourth configuration 1214. The first configuration 1211 is the same as the fourth configuration 714, containing the SYNC preamble 720, the SFD 730, and the STS preamble 760. The first configuration 1211 thus provides legacy support. The second configuration 1212 contains the SYNC preamble 720 only. The third configuration 1213 contains the STS only. The fourth configuration 1214 contains a customized sequence 1220. The customized sequence 1220 may be determined by an upper layer entity (e.g., the server 400 (e.g., an LMF) or an upper-layer application running on the UE 500) and may be based on a technology other than UWB, e.g., NR. The customized sequence 1220) may be for sensing, or may be a preamble but based on a sequence other than an Ipatov sequence. The customized sequence may, for example, be a variant of the SYNC preamble 720 or a variant of the STS preamble 760. The fourth configuration 1214 may enable new applications (such as sensing) where a different preamble sequence is transmitted (different from the SYNC preamble 720 and the STS preamble 760).

Referring also to FIGS. 13 and 14, OOB signals for time and frequency synchronization (time/frequency synchronization) may be disposed close in time and frequency to UWB signals used for ranging. In order to help ensure accurate frequency synchronization, an OOB signal for frequency synchronization may have a carrier frequency within or near a UWB channel frequency band. For example, as shown in FIG. 13, a UWB frequency band 1310 (from 3.1 GHz to 10.6 GHZ) contains channels 1-14 within a low band 1320 and a high band 1330, respectively, with the UWB frequency band 1310 being well above a sub-GHz band 1340 and the channels 1-14 spanning respective frequency bands. For example, a first OOB signal 1351 may be provided for time and frequency synchronization with a carrier frequency 1361 being near the frequency band of UWB channel 5. The first OOB signal 1351 may be a UNII-3 signal (e.g., for Zigbee R, with a carrier frequency of about 5.8 GHZ). UWB channels may be used to take advantage of OOB signals (e.g., PRS) near or overlapping with the UWB channels. For example, a second OOB signal 1352 may have a carrier frequency 1362 within one of the UWB channel frequency bands, here the frequency band of UWB channel 8. As another example, a third OOB signal 1353 may have a carrier frequency 1363 near (e.g., within a threshold of) one of the UWB channel frequency bands, here the frequency band of UWB channel 1. The OOB signal may be within a threshold of a frequency band of a UWB channel where the threshold helps ensure a frequency synchronization within a desired (e.g., threshold) accuracy.

As shown in FIG. 14, an OOB signal 1410 (e.g., one of the OOB signals 1351-1353) for time synchronization is transmitted close in time to transmission of a UWB signal 1420 used for ranging, e.g., within a threshold time of transmission of the UWB signal 1420 such that the time synchronization derived from the OOB signal 1410 will still be within a desired accuracy at the time of transmission of the UWB signal 1420. In this example, the OOB signal 1410 is scheduled before a UWB ranging block 1430 but near in time to a slot 1440 within a round 1450 of the UWB ranging block 1430, with the slot 1440 corresponding to a message for ranging that will use the UWB signal 1420 (here the SYNC preamble alone). The UWB ranging block 1430 is a time span divided into multiple rounds corresponding to different potential UWB sessions with each round divided into slots for respective messages in the respective sessions. Multiple UEs 500 may agree on (e.g., explicitly chosen or randomly selected) which round to use for a UWB session. Thus, if there are multiple sessions ongoing, using different rounds will help reduce collisions and interference between sessions. Also in this example, the OOB signal 1410 for time synchronization is a PRS signal and the UWB signal 1420 for ranging is the SYNC preamble alone.

To help ensure that an OOB signal for time/frequency synchronization is near in frequency and time to a UWB signal used for ranging, the UE 500 may provide information as to the UWB signal and/or request characteristics of the OOB signal. For example, the synch unit 550 may transmit a capability message to the network entity 600 indicating which UWB channel(s) the UE 500 can use, and indicating an interest in receiving time/frequency synchronization assistance using an OOB signal (e.g., an NR signal). The network entity 600 may schedule an OOB signal according to the capability (ies) of the UE 500 indicating in the capability message. The UE 500 may adjust a UWB session according to the scheduled OOB signal (e.g., a periodic PRS) to accommodate the scheduled OOB signal. As another example, the synch unit 550 may request an on-demand OOB signal (e.g., on-demand PRS) to fit within a UWB session, e.g., with a specific carrier frequency or a carrier frequency within a specified frequency band, and may specify a timing of the on-demand OOB signal (e.g., to be close in time with a UWB signal for ranging). The network entity 600 may configure an OOB signal (e.g., PRS) to have a carrier frequency in or near a frequency band of a specified UWB channel or with a carrier frequency meeting a specified criterion. The UE 500 will want the OOB signal to be close in time and frequency to an agreed upon slot, and thus the UE 500 may schedule the UWB session based on an OOB (e.g., PRS) schedule or may request an on-demand OOB signal (frequency and/or timing of the on-demand OOB signal) to schedule the OOB signal based on the UWB session and an expected (e.g., scheduled) frequency (e.g., frequency band) of a UWB signal and/or expected (e.g., scheduled) timing of the UWB signal. The expected frequency (e.g., frequency band) of the UWB signal may be based on the UWB frequency (ies) that the UE 500 is capable of processing. Multiple UEs 500 may leverage a common clock, e.g., by using the same OOB signal (e.g., from the same TRP 300) or multiple OOB signals from multiple TRPs 300 that are synchronized (e.g., being in the same base station), for time/frequency synchronization which helps the synchronization between the UEs 500. The common clock (i.e., common to the UEs) may be coordinated by the network entity 600 (e.g., an LMF).

Sidelink sessions may be leveraged to assist with UWB ranging. For example, a pair of UEs 500 may transfer sidelink signals in a sidelink session, e.g., to perform sidelink positioning, using a 100 MHz channel. The UWB unit 560 of one or more of the UEs 500 may provide capability information, in one or more capability messages, to the network entity 600 about a capability of performing ranging measurements using UWB. The UEs 500 may use time and frequency synchronization information obtained from the sidelink session to begin a UWB session for ranging, which may provide enhanced accuracy compared to ranging based on the sidelink session (e.g., due to a 500 MHz channel in the UWB session compared to the 100 MHz channel in the sidelink session). The UEs 500 may use time and frequency synchronization information obtained from the sidelink session to perform channel estimation, and transmit a partial-frame UWB frame (e.g., the SYNC preamble alone, or the STS alone) for ranging. The network entity 600 can transmit one or more messages to the UEs 500 to indicate the sidelink channel (e.g., an NR channel) for the UEs 500 to use for the sidelink session and a UWB channel for the UEs 500 to use for the UWB session. The UEs 500 can use the indicated SL channel for an SL session (that may already exist or that is initiated after the message(s) from the network entity) and use the indicated UWB channel for ranging.

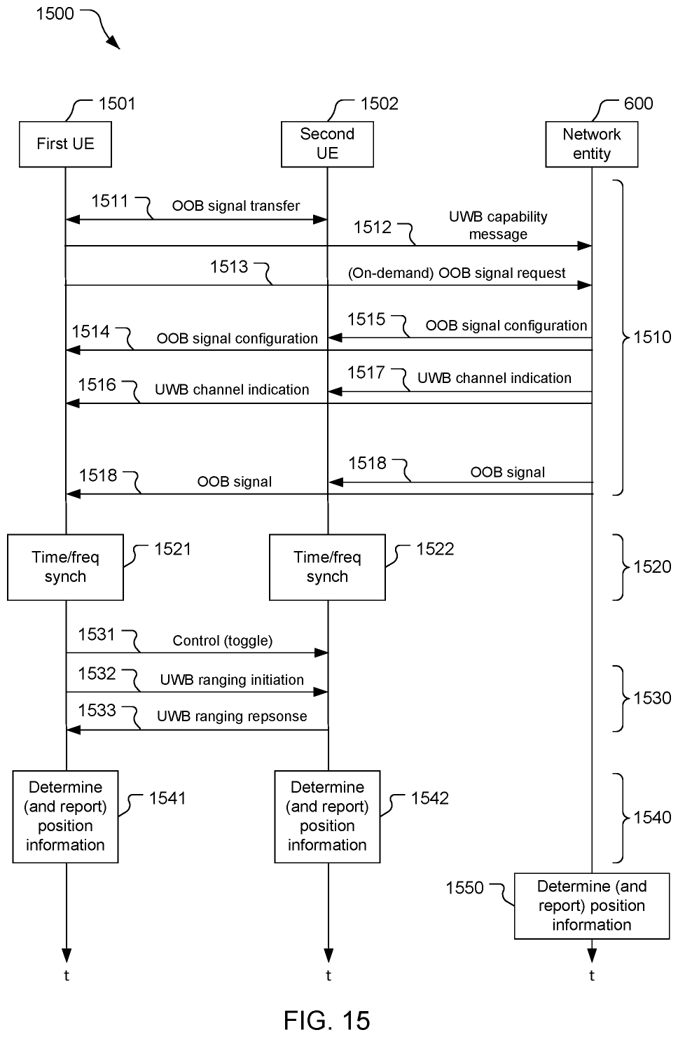

Referring to FIG. 15, with further reference to FIGS. 1-14, a timing diagram shows a signaling and process flow 1500 for UWB ranging between a first UE 1501 and a second UE 1502, with the flow 1500 including the stages shown. The UEs 1501, 1502 may each be an ERDEV (Enhanced Ranging Device). Other flows are possible, e.g., with one or more stages shown omitted, one or more stages added, and/or one or more stages shown altered. For example, if sidelink signal transfer is used for time/frequency synchronization, then stage 1520 may be omitted and stage 1530 may be performed during stage 1510. As another example, signal transfer at stage 1510 may be one way even though a double-sided arrow is shown. As another example, one or more of sub-stages 1541, 1542 and/or stage 1550 may be omitted. Still other flows may be used.

At stage 1510, an OOB signal transfer session is established and one or more OOB signals transferred for time/frequency synchronization to facilitate a UWB session between the UEs 1501, 1502. For example, one or more OOB signals 1511 may be transferred between the UEs 1501, 1502 (i.e., to the second UE 1502 from the first UE 1501 and/or from the second UE 1502 to the first UE 1501). For example, the first UE 1501 may send a ranging control message (RCM) to the second UE 1502, in which case the first UE 1501 may be called a controller and the second UE 1502 may be called a controlee. The RCM is an OOB signal (e.g., Bluetooth®), Zigbee R), NR, etc.) that sets up a UWB session. The RCM includes an application-layer packet with high-level parameters (e.g., UWB channel indication) that helps the UEs 1501, 1502 agree to when to begin a UWB session and how to operate in the UWB session. As another example, either or both of the UEs 1501, 1502 may transmit one or more SL signals to the other UE 1501, 1502. As part of an SL session, the UEs 1501, 1502 may perform time/frequency synchronization.

The first UE 1501 may transmit a UWB capability message 1512 to the network entity 600. Also or alternatively, although not shown, the second UE 1502 may transmit a UWB capability message to the network entity 600. The UWB capability message 1512 may indicate, for example, one or more UWB channels over which the first UE 1501 may operate and an interest by the first UE 1501 in receiving time/frequency synchronization assistance using OOB signaling (e.g., NR signaling). The UWB capability message 1512 may serve as an implicit request for an on-demand OOB signal (e.g., PRS) that has a frequency near to or overlapping with one of the indicated UWB channels and that is near in time to a time to be used by the first UE 1501 for a UWB message to the second UE 1502 (e.g., the slot 1440).

The first UE 1501 may transmit an OOB signal request 1513 to the network entity 600. The OOB signal request 1513 may be part of the UWB capability message 1512. The OOB signal request 1513 may explicitly request an OOB signal that is near in time and frequency to one or more UWB signals to be sent or received by the first UE 1501. The OOB signal request 1513 may be a request for an on-demand OOB signal, such as an on-demand PRS, with the OOB signal request 1513 indicating a desired frequency or frequency band of the OOB signal and indicating a desired transmission time of the OOB signal or indicating a time of a UWB communication to which the OOB signal is requested to be near in time.

The network entity 600, e.g., the UWB unit 650, transmits OOB signal configurations 1514, 1515 to the UEs 1501, 1502, respectively. For example, the OOB signal configurations 1514, 1515 may indicate a configuration of a DL RS, e.g., DL PRS, to be transmitted by the network entity 600 for time/frequency synchronization by the UEs 1501, 1502. The OOB signal configurations 1514, 1515 may be based on the UWB capability message 1512 and the OOB signal request, e.g., based on frequency of the supported UWB channel(s) or requested frequency, and based explicitly or implicitly on requested timing of the OOB signal. As another example, the OOB signal configurations 1514, 1515 may indicate a configuration of an SL RS to be transmitted by one of the UEs 1501, 1502 to the other UE 1501, 1502, e.g., to help with time/frequency synchronization for a UWB session. The OOB signal configurations 1514, 1515 may help the UEs 1501, 1502 to take advantage of OOB signal measurements along with initiating a UWB session between the UEs 1501, 1502.

The network entity 600, e.g., the UWB unit 650, may transmit a UWB channel indication message 1516, 1517 to the UEs 1501, 1502, respectively. For example, the UWB channel indication messages 1516, 1517 may indicate a UWB channel for the UEs 1501, 1502 to use for UWB ranging, e.g., based on time and/or frequency to the scheduled OOB signal. As another example, if the UEs 1501, 1502 have been engaged in an SL session, then the network entity 600 may have indicated to the UEs 1501, 1502 (already and/or in the indication messages 1516, 1517) which SL channel to use for the SL session, and may base which UWB channel to use on the SL channel used for the SL session.

The network entity 600 (e.g., the TRP 300 or a TRP portion of the network entity 600), e.g., the UWB unit 650, may transmit an OOB signal 1518 to the UEs 1501, 1502. The synch unit 550 of each of the UEs 1501, 1502 may measure the OOB signal 1518 for time/frequency synchronization. The timing synchronization may thus be derived from a common clock (e.g., coordinated by the network entity (e.g., an LMF)). Alternatively, if the UEs 1501, 1502 have been engaged in an SL session, then one or more OOB signals 1511 sent between the UEs 1501, 1502 may be used for time/frequency synchronization.

At stage 1520, the UEs 1501, 1502 perform time/frequency synchronization. For example, at sub-stages 1521, 1522, the synch unit 550 of each the UEs 1501, 1502 may measure the OOB signal 1518, if transmitted, from the network entity 600 to perform time/frequency synchronization. As another example, at sub-stage 1521, the first UE 1501 may perform time/frequency synchronization based on an OOB signal sent from the first UE 1501 in sidelink to the second UE 1502 and at sub-stage 1522 the second UE 1502 may perform time/frequency synchronization based on the OOB signal received from the first UE 1501. As another example, at sub-stage 1522, the second UE 1502 may perform time/frequency synchronization based on an OOB signal sent from the second UE 1502 in sidelink to the first UE 1501 and the first UE 1501 may perform time/frequency synchronization based on the OOB signal received from the second UE 1502.

At stage 1530, the UEs 1501, 1502 conduct a UWB ranging session. The UE 1501 may transmit a UWB control message 1531 indicating a UWB frame configuration, e.g., a set of possible frame configurations that may be used for a subsequent UWB frame. For example, the UWB control message 1531 may toggle between the configurations 711-714 and another set of configurations such as the configurations 1211-1214 as the set of possible configurations. As another example, the UWB control message 1531 may not be transmitted, with the OOB signals 1511 including an upper-layer control message indicating the UWB frame configuration (e.g., set of possible UWB frame configurations). For example, in FiRa, the UWB frame configuration may be determined by an upper layer message (e.g., UCI), implying that the configuration cannot change between UWB rounds as an OOB setup would be used to set the configuration. In the example shown, the first UE 1501 transmits a UWB ranging initiation message 1532 to the second UE 1502 and the second UE 1502 responds by sending a UWB ranging response message 1533. In this case, the first UE 1501 may be referred to as the initiator and the second UE 1502 may be referred to as the responder. In the example discussed, the first UE 1501 was the controller and the initiator and the second UE 1502 was the controlee and the responder, but the controlee could be the initiator and the controller could be the responder. The UWB ranging initiation message 1532 may contain a partial-frame UWB physical-layer signal (i.e., less than a full-frame physical-layer UWB signal), e.g., containing the SYNC preamble 720 alone or the STS preamble 760 alone, or other content (e.g., customized content).

At stage 1540, the UEs 1501, 1502 may determine, and possibly report, position information. For example, at sub-stage 1542 the UWB unit 560 of the second UE 1502 may measure the received UWB ranging initiation message 1532 and/or at sub-stage 1541 the UWB unit 560 of the first UE 1501 may measure the received UWB ranging response message 1533, e.g., to determine position information (e.g., ToA, AoA, etc.). Either or both of the UEs 1501, 1502 may report some or all of the determined position information, e.g., to the other of the UEs 1501, 1502 and/or to the network entity 600. Either of the UEs 1501, 1502 may use the position information received from the other UE 1501, 1502 to determine, and possibly report, further position information (e.g., range to the other UE 1501, 1502, position estimate for one or more of the UEs 1501, 1502, etc.).

At stage 1550, the network entity 600 determines position information. The network entity 600 may determine position information from position information (e.g., one or more raw measurements and/or one or more processed measurements (e.g., range(s)) reported by one or more of the UEs 1501, 1502. For example, the network entity 600 may determine a range between the UEs 1501, 1502 and/or a position estimate for the first UE 1501 and/or a position estimate for the second UE 1502. The network entity 600 may report position information to one or more of the UEs 1501, 1502 (e.g., position information not provided by the respective UE 1501, 1502).

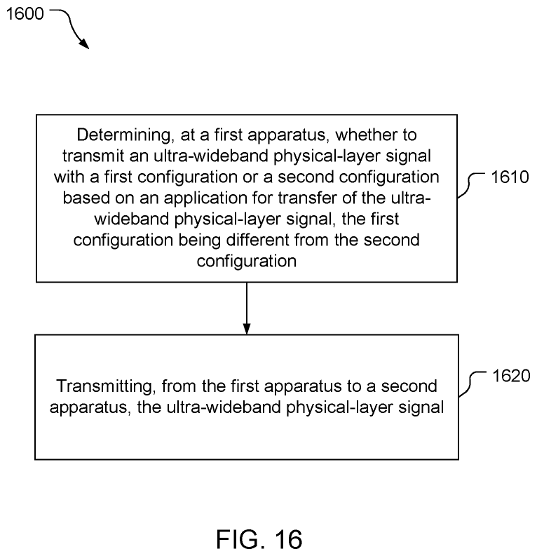

Referring to FIG. 16, with further reference to FIGS. 1-15, a signal transfer method 1600 includes the stages shown. The method 1600 is, however, an example and not limiting. The method 1600 may be altered, e.g., by having stages added, removed, rearranged, combined, performed concurrently, and/or having single stages split into multiple stages.

At stage 1610, the method 1600 includes determining, at a first apparatus, whether to transmit an ultra-wideband physical-layer signal with a first configuration or a second configuration based on an application for transfer of the ultra-wideband physical-layer signal, the first configuration being different from the second configuration. For example, the first UE 1501 may determine whether to transmit a full-frame UWB signal (e.g., according to one of the configurations 711-714) or a partial-frame UWB signal (e.g., according to one of the configurations 1212-1214). The processor 510, possibly in combination with the memory 530, may comprise means for determining whether to transmit a UWB physical-layer signal with the first configuration or the second configuration.

At stage 1620, the method 1600 includes transmitting, from the first apparatus to a second apparatus, the ultra-wideband physical-layer signal. For example, the first UE 1501 transmits the UWB ranging initiation message 1532, e.g., being a partial-frame physical-layer signal (e.g., the SYNC preamble 720 alone, the STS preamble 760 alone, or a customized sequence alone). The processor 510, possibly in combination with the memory 530, possibly in combination with the transceiver 520 (e.g., the wireless transmitter 242 and the antenna 246) may comprise means for transmitting the ultra-wideband physical-layer signal. Transmitting a partial-frame UWB physical-layer signal may allow a UE to use more power for a signal used for ranging than if a full-frame signal is transmitted.

Implementations of the method 1600 may include one or more of the following features. In an example implementation, the first configuration includes a synchronization preamble and includes a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble. For example, the first UE 1501 may decide between transmitting the UWB physical-layer signal with one of the configurations 711-714 or with one of the configurations 1212, 1213. In a further example implementation, the method 1600 includes transmitting, from the first apparatus, a higher-layer signal, using a protocol layer above a physical layer in a protocol stack, wherein the higher-layer signal indicates whether the first apparatus will transmit the ultra-wideband physical-layer signal with the first configuration or the second configuration. For example, the first UE 1501 transmits the UWB control message 1531 indicating a configuration (or a potential set of configurations) that will be used for the UWB physical-layer signal. As another example, the first UE 1501 transmits one or more OOB signals of the one or more OOB signals 1511, indicating a configuration (or a potential set of configurations) that will be used for the UWB physical-layer signal. The processor 510, possibly in combination with the memory 530, possibly in combination with the transceiver 520 (e.g., the wireless transmitter 242 and the antenna 246) may comprise means for transmitting the higher-layer signal.

Also or alternatively, implementations of the method 1600 may include one or more of the following features. In an example implementation, the method 1600 includes transmitting, from the first apparatus, a higher-layer signal, using a protocol layer above a physical layer in a protocol stack, wherein the higher-layer signal indicates that the first apparatus will transmit the ultra-wideband physical-layer signal with the first configuration, wherein the first configuration is based on a non-ranging application for the ultra-wideband physical-layer signal. For example, the UE 500 may indicate (e.g., in one or more of the one or more OOB signals 1511, or in the UWB control message 1531, in a MAC layer or another layer) that a full-frame UWB signal will be sent based on a sensing (and not ranging) application use for the UWB physical-layer signal. In another example implementation, the method 1600 includes transmitting, from the first apparatus, a higher-layer signal, using a protocol layer above a physical layer in a protocol stack, wherein the higher-layer signal indicates whether the first apparatus will transmit the ultra-wideband physical-layer signal with: a synchronization preamble and a physical-layer payload, or a scrambled timestamp sequence preamble, or a combination thereof; or the synchronization preamble alone; or the scrambled timestamp sequence preamble alone; or another sequence. For example, the UE 500 may indicate (e.g., in one or more of the one or more OOB signals 1511, or in the UWB control message 1531, in a MAC layer or another layer) that the UWB physical layer signal will be sent using one of the configurations 1211-1214. In another example implementation, the application for transfer of the ultra-wideband physical-layer signal is a ranging application or a channel estimation application. For example, the UWB unit 560 of the first UE 1501 may determine which configuration to use for the UWB physical-layer signal based on whether the signal is to be used for ranging or sensing, e.g., determining to use a partial-frame configuration if the signal is to be used for ranging.

Also or alternatively, implementations of the method 1600 may include one or more of the following features. In an example implementation, the ultra-wideband physical-layer signal is a first ultra-wideband physical-layer signal, and wherein the signal transfer method further includes: transmitting, from the first apparatus to a network entity, a request for a non-ultra-wideband signal; receiving the non-ultra-wideband signal at the first apparatus; measuring the non-ultra-wideband signal at the first apparatus; performing, at the first apparatus, time and frequency synchronization based on measurement of the non-ultra-wideband signal; and performing, at the first apparatus, signal transfer of a second ultra-wideband physical-layer signal based on the time and frequency synchronization. For example, the first UE 1501 transmits the UWB capability message 1512 and/or the OOB signal request 1513 to request, implicitly and/or explicitly, an OOB signal for time/frequency synchronization. The first UE 1501 receives and measures the OOB signal 1518 and performs time/frequency synchronization based on the OOB signal 1518. The first UE 1501 performs signal transfer of a second UWB physical-layer signal based on the time/frequency synchronization, e.g., transmitting the first UWB physical-layer signal (e.g., the UWB ranging initiation message 1532) or receiving (and possibly measuring) a different UWB physical layer signal (e.g., the UWB ranging response message 1533). The processor 510, possibly in combination with the memory 530, possibly in combination with the transceiver 520 (e.g., the wireless transmitter 242 and the antenna 246) may comprise means for transmitting the request for the non-ultra-wideband signal and possibly the means for performing the signal transfer of the second UWB physical-layer signal. The processor 510, possibly in combination with the memory 530, possibly in combination with the transceiver 520 (e.g., the wireless receiver 244 and the antenna 246) may comprise means for receiving the non-ultra-wideband signal and possibly the means for performing the signal transfer of the second UWB physical-layer signal. The processor 510, possibly in combination with the memory 530, may comprise means for measuring the non-ultra-wideband signal and means for performing time and frequency synchronization. In a further example implementation, the request for the non-ultra-wideband signal includes an explicit request for an on-demand reference signal. In a further example implementation, the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal. In another further example implementation, the request for the non-ultra-wideband signal includes an indication of one or more ultra-wideband channels in which the first apparatus is configured for operation. The request may indicate a UWB channel supported by the first UE 1501 as an implicit request for an OOB signal in or near the frequency of that channel, although the request may also include an explicit request for time/frequency synchronization assistance using an OOB signal (e.g., an NR signal).

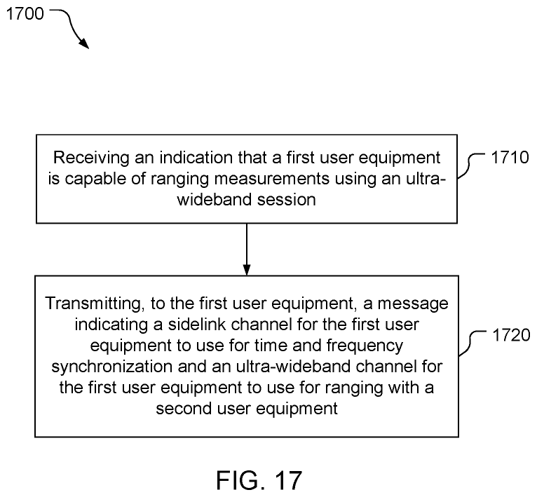

Referring to FIG. 17, with further reference to FIGS. 1-15, an ultra-wideband ranging assistance method 1700 includes the stages shown. The method 1700 is, however, an example and not limiting. The method 1700 may be altered, e.g., by having stages added, removed, rearranged, combined, performed concurrently, and/or having single stages split into multiple stages.

At stage 1710, the method 1700 includes receiving an indication that a first user equipment is capable of ranging measurements using an ultra-wideband session. For example, the network entity 600 receives the UWB capability message 1512 and possibly the OOB signal request 1513. The processor 610, possibly in combination with the memory 630, possibly in combination with the transceiver 620 (e.g., the wireless receiver 444 and the antenna 446 and/or the wired receiver 454, and/or the wireless receiver 344 and the antenna 346) may comprise means for receiving the indication.

At stage 1720, the method 1700 includes transmitting, to the first user equipment, a message indicating a sidelink channel for the first user equipment to use for time and frequency synchronization and an ultra-wideband channel for the first user equipment to use for ranging with a second user equipment. For example, the network entity 600 transmits the UWB channel indication message 1516 to the first UE 1501 to indicate the sidelink channel and the UWB channel for the UE 1501 to use for sidelink signaling and UWB ranging with the second UE 1502, respectively. The processor 610, possibly in combination with the memory 630, possibly in combination with the transceiver 620 (e.g., the wireless transmitter 442 and the antenna 446 and/or the wired transmitter 452, and/or the wireless transmitter 342 and the antenna 346) may comprise means for transmitting the message indicating the sidelink channel and the UWB channel.

Implementations of the method 1700 may include one or more of the following features. In an example implementation, the method 1700 includes determining the sidelink channel based on the indication indicating the ultra-wideband channel. For example, the network entity 600 may determine the sidelink channel based on the UWB capability message 1512 indicating the UWB channel that the network entity 600 indicates for the first UE 1501 to user equipment to use for sidelink signaling with the second UE 1502. In another example implementation, the method 1700 includes transmitting, to the first user equipment and the second user equipment, a broadcast out-of-band reference signal for the first user equipment and the second user equipment to use for time and frequency synchronization. For example, the network entity 600 transmits the OOB signal 1518 to the UEs 1501, 1502 for performing time/frequency synchronization at stage 1520. The processor 610, possibly in combination with the memory 630, possibly in combination with the transceiver 620 (e.g., the wireless transmitter 442 and the antenna 446 and/or the wired transmitter 452, and/or the wireless transmitter 342 and the antenna 346) may comprise means for transmitting the broadcast OOB reference signal.

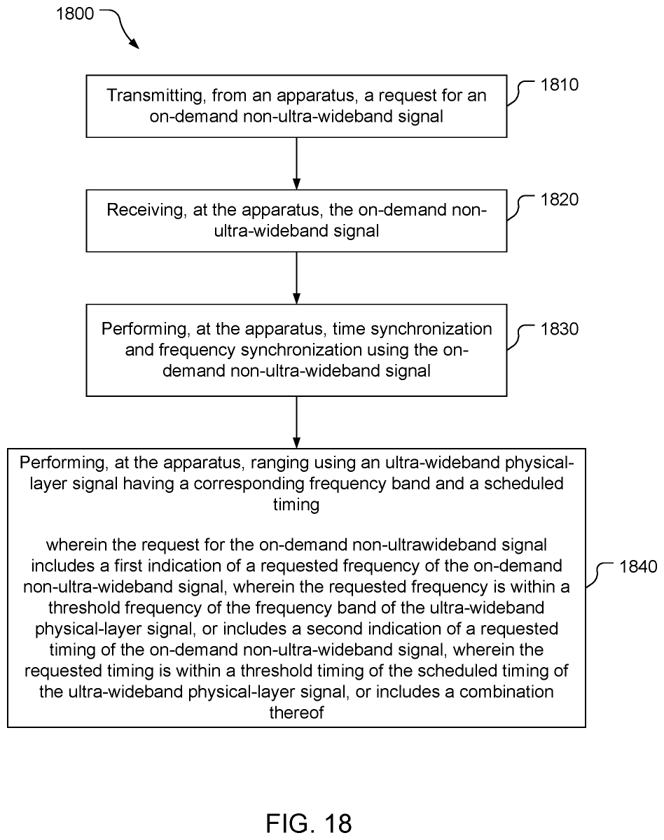

Referring to FIG. 18, with further reference to FIGS. 1-15, a ranging method 1800 includes the stages shown. The method 1800 is, however, an example and not limiting. The method 1800 may be altered, e.g., by having stages added, removed, rearranged, combined, performed concurrently, and/or having single stages split into multiple stages.

At stage 1810, the method 1800 includes transmitting, from an apparatus, a request for an on-demand non-ultra-wideband signal. For example, the first UE 1501 transmits the OOB signal request 1513 to the network entity 600 requesting an on-demand OOB signal. The processor 510, possibly in combination with the memory 530, in combination with the transceiver 520 (e.g., the wireless transmitter 242 and the antenna 246) may comprise means for transmitting the request for the on-demand non-ultra-wideband signal.

At stage 1820, the method 1800 includes receiving, at the apparatus, the on-demand non-ultra-wideband signal. For example, the first UE 1501 receives the OOB signal 1518. The processor 510, possibly in combination with the memory 530, in combination with the transceiver 520 (e.g., the wireless receiver 244 and the antenna 246) may comprise means for receiving the on-demand non-ultra-wideband signal.

At stage 1830, the method 1800 includes performing, at the apparatus, time synchronization and frequency synchronization using the on-demand non-ultra-wideband signal. For example, synch unit 550 of the first UE 1501 performs time and frequency synchronization at sub-stage 1521 using the OOB signal 1518. The processor 510, possibly in combination with the memory 530, may comprise means for performing time and frequency synchronization using the on-demand non-ultra-wideband signal.

At stage 1840, the method 1800 includes performing, at the apparatus, ranging using an ultra-wideband physical-layer signal having a corresponding frequency band and an expected timing, where the request for the on-demand non-ultra-wideband signal includes a first indication of a requested frequency of the on-demand non-ultra-wideband signal, where the requested frequency is within a threshold frequency of the frequency band of the ultra-wideband physical-layer signal, or includes a second indication of a requested timing of the on-demand non-ultra-wideband signal, where the requested timing is within a threshold timing of the expected timing of the ultra-wideband physical-layer signal, or includes a combination thereof. For example, the UWB unit 560 of the first UE 1501 may transmit the UWB ranging initiation message 1532 (or a UWB ranging response message) and may receive the UWB ranging response message 1533. The UWB unit 560 of the first UE 1501 may determine position information at sub-stage 1541, e.g., measure the UWB ranging response message 1533, determine a range to the second UE 1502, and/or determine a location estimate for the first UE 1501, etc. For example, the UWB unit 560 of the first UE 1501 receives the UWB ranging response message 1533, that has a corresponding frequency and an expected timing (e.g., scheduled timing). The corresponding frequency may be a scheduled frequency or frequency band of the UWB signal and/or may be an assumed frequency band or frequency based on one or more frequency bands supported by the first UE 1501. The processor 510, possibly in combination with the memory 530, in combination with the transceiver 520 (e.g., the wireless receiver 244 and the antenna 246 and/or the wireless transmitter 242 and the antenna 246) may comprise means for performing ranging using the ultra-wideband physical-layer signal.

Implementations of the method 1800 may include one or more of the following features. In an example implementation, the first indication of the requested frequency indicates the frequency band of the ultra-wideband physical-layer signal. In another example implementation, the second indication of the requested timing indicates the expected timing of the ultra-wideband physical-layer signal.

### Implementation Examples

Implementation examples are provided in the following numbered clauses.

Clause 1. An apparatus comprising:
a transceiver configured to transmit and receive ultra-wideband signals;
a memory; and
a processor, communicatively coupled to the memory and the transceiver, configured to:
   determine whether to transmit an ultra-wideband physical-layer signal with a first configuration or a second configuration based on an application for transfer of the ultra-wideband physical-layer signal, the first configuration being different from the second configuration; and
   transmit, via the transceiver, the ultra-wideband physical-layer signal.

Clause 2. The apparatus of clause 1, wherein the first configuration includes a synchronization preamble and includes a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

Clause 3. The apparatus of clause 2, wherein the processor is configured to transmit, via the transceiver, a higher-layer signal, using a protocol layer above a physical layer in a protocol stack, wherein the higher-layer signal indicates whether the apparatus will transmit the ultra-wideband physical-layer signal with the first configuration or the second configuration.

Clause 4. The apparatus of clause 1, wherein the processor is configured to transmit, via the transceiver, a higher-layer signal, using a protocol layer above a physical layer in a protocol stack, wherein the higher-layer signal indicates that the apparatus will transmit the ultra-wideband physical-layer signal with the first configuration, wherein the first configuration is based on a non-ranging application for the ultra-wideband physical-layer signal.

Clause 5. The apparatus of clause 1, wherein the processor is configured to transmit, via the transceiver, a higher-layer signal, using a protocol layer above a physical layer in a protocol stack, wherein the higher-layer signal indicates whether the apparatus will transmit the ultra-wideband physical-layer signal with:
a synchronization preamble and a physical-layer payload, or a scrambled timestamp sequence preamble, or a combination thereof; or
the synchronization preamble alone; or
the scrambled timestamp sequence preamble alone; or
another sequence.

Clause 6. The apparatus of clause 1, wherein the application for transfer of the ultra-wideband physical-layer signal is a ranging application or a channel estimation application.

Clause 7. The apparatus of clause 1, wherein the ultra-wideband physical-layer signal is a first ultra-wideband physical-layer signal, and wherein the processor is configured to:
transmit, via the transceiver to a network entity, a request for a non-ultra-wideband signal;
receive the non-ultra-wideband signal;
measure the non-ultra-wideband signal;
perform time and frequency synchronization based on measurement of the non-ultra-wideband signal; and
perform signal transfer of a second ultra-wideband physical-layer signal based on the time and frequency synchronization.

Clause 8. The apparatus of clause 7, wherein the request for the non-ultra-wideband signal includes an explicit request for an on-demand reference signal.

Clause 9. The apparatus of clause 8, wherein the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal.

Clause 10. The apparatus of clause 7, wherein the request for the non-ultra-wideband signal includes an indication of one or more ultra-wideband channels in which the apparatus is configured for operation.

Clause 11. An signal transfer method comprising:
determining, at a first apparatus, whether to transmit an ultra-wideband physical-layer signal with a first configuration or a second configuration based on an application for transfer of the ultra-wideband physical-layer signal, the first configuration being different from the second configuration; and
transmitting, from the first apparatus to a second apparatus, the ultra-wideband physical-layer signal.

Clause 12. The signal transfer method of clause 11, wherein the first configuration includes a synchronization preamble and a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

Clause 13. The signal transfer method of clause 12, further comprising transmitting, from the first apparatus, a higher-layer signal, using a protocol layer above a physical layer in a protocol stack, wherein the higher-layer signal indicates whether the first apparatus will transmit the ultra-wideband physical-layer signal with the first configuration or the second configuration.

Clause 14. The signal transfer method of clause 11, further comprising transmitting, from the first apparatus, a higher-layer signal, using a protocol layer above a physical layer in a protocol stack, wherein the higher-layer signal indicates that the first apparatus will transmit the ultra-wideband physical-layer signal with the first configuration, wherein the first configuration is based on a non-ranging application for the ultra-wideband physical-layer signal.

Clause 15. The signal transfer method of clause 11, further comprising transmitting, from the first apparatus, a higher-layer signal, using a protocol layer above a physical layer in a protocol stack, wherein the higher-layer signal indicates whether the first apparatus will transmit the ultra-wideband physical-layer signal with:
a synchronization preamble and a frame body, wherein the frame body includes a physical-layer payload, or a scrambled timestamp sequence preamble, or a combination thereof; or
the synchronization preamble alone; or
the scrambled timestamp sequence preamble alone; or
another sequence.

Clause 16. The signal transfer method of clause 11, wherein the application for transfer of the ultra-wideband physical-layer signal is a ranging application or a channel estimation application.

Clause 17. The signal transfer method of clause 11, wherein the ultra-wideband physical-layer signal is a first ultra-wideband physical-layer signal, and wherein the signal transfer method further comprises:
transmitting, from the first apparatus to a network entity, a request for a non-ultra-wideband signal;
receiving the non-ultra-wideband signal at the first apparatus; measuring the non-ultra-wideband signal at the first apparatus;
performing, at the first apparatus, time and frequency synchronization based on measurement of the non-ultra-wideband signal; and
performing, at the first apparatus, signal transfer of a second ultra-wideband physical-layer signal based on the time and frequency synchronization.

Clause 18. The signal transfer method of clause 17, wherein the request for the non-ultra-wideband signal includes an explicit request for an on-demand reference signal.

Clause 19. The signal transfer method of clause 18, wherein the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal.

Clause 20. The signal transfer method of clause 17, wherein the request for the non-ultra-wideband signal includes an indication of one or more ultra-wideband channels in which the first apparatus is configured for operation.

Clause 21. An apparatus comprising:
means for determining whether to transmit an ultra-wideband physical-layer signal with a first configuration or a second configuration based on an application for transfer of the ultra-wideband physical-layer signal, the first configuration being different from the second configuration; and
means for transmitting the ultra-wideband physical-layer signal.

Clause 22. The apparatus of clause 21, wherein the first configuration includes a synchronization preamble and a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

Clause 23. The apparatus of clause 22, further comprising means for transmitting a higher-layer signal, using a protocol layer above a physical layer in a protocol stack, wherein the higher-layer signal indicates whether the apparatus will transmit the ultra-wideband physical-layer signal with the first configuration or the second configuration.

Clause 24. The apparatus of clause 21, further comprising means for transmitting a higher-layer signal, using a protocol layer above a physical layer in a protocol stack, wherein the higher-layer signal indicates that the apparatus will transmit the ultra-wideband physical-layer signal with the first configuration, wherein the first configuration is based on a non-ranging application for the ultra-wideband physical-layer signal.

Clause 25. The apparatus of clause 21, further comprising means for transmitting a higher-layer signal, using a protocol layer above a physical layer in a protocol stack, wherein the higher-layer signal indicates whether the apparatus will transmit the ultra-wideband physical-layer signal with:
a synchronization preamble and a physical-layer payload, or a scrambled timestamp sequence preamble, or a combination thereof; or
the synchronization preamble alone; or
the scrambled timestamp sequence preamble alone; or
another sequence.

Clause 26. The apparatus of clause 21, wherein the application for transfer of the ultra-wideband physical-layer signal is a ranging application or a channel estimation application.

Clause 27. The apparatus of clause 21, wherein the ultra-wideband physical-layer signal is a first ultra-wideband physical-layer signal, and wherein the apparatus further comprises:
means for transmitting, to a network entity, a request for a non-ultra-wideband signal;
means for receiving the non-ultra-wideband signal;
means for measuring the non-ultra-wideband signal;
means for performing time and frequency synchronization based on measurement of the non-ultra-wideband signal; and
means for performing signal transfer of a second ultra-wideband physical-layer signal based on the time and frequency synchronization.

Clause 28. The apparatus of clause 27, wherein the request for the non-ultra-wideband signal includes an explicit request for an on-demand reference signal.

Clause 29. The apparatus of clause 28, wherein the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal.

Clause 30. The apparatus of clause 27, wherein the request for the non-ultra-wideband signal includes an indication of one or more ultra-wideband channels in which the apparatus is configured for operation.

Clause 31. A non-transitory, processor-readable storage medium comprising processor-readable instructions to cause a processor of an apparatus to:
determine whether to transmit an ultra-wideband physical-layer signal with a first configuration or a second configuration based on an application for transfer of the ultra-wideband physical-layer signal, the first configuration being different from the second configuration; and
transmit the ultra-wideband physical-layer signal.

Clause 32. The non-transitory, processor-readable storage medium of clause 31, wherein the first configuration includes a synchronization preamble and a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

Clause 33. The non-transitory, processor-readable storage medium of clause 32, further comprising processor-readable instructions to cause the processor to transmit a higher-layer signal, using a protocol layer above a physical layer in a protocol stack, wherein the higher-layer signal indicates whether the apparatus will transmit the ultra-wideband physical-layer signal with the first configuration or the second configuration.

Clause 34. The non-transitory, processor-readable storage medium of clause 31, further comprising processor-readable instructions to cause the processor to transmit a higher-layer signal, using a protocol layer above a physical layer in a protocol stack, wherein the higher-layer signal indicates that the apparatus will transmit the ultra-wideband physical-layer signal with the first configuration, wherein the first configuration is based on a non-ranging application for the ultra-wideband physical-layer signal.

Clause 35. The non-transitory, processor-readable storage medium of clause

31, further comprising processor-readable instructions to cause the processor to transmit a higher-layer signal, using a protocol layer above a physical layer in a protocol stack, wherein the higher-layer signal indicates whether the apparatus will transmit the ultra-wideband physical-layer signal with:
a synchronization preamble and a physical-layer payload, or a scrambled timestamp sequence preamble, or a combination thereof; or
the synchronization preamble alone; or
the scrambled timestamp sequence preamble alone; or
another sequence.

Clause 36. The non-transitory, processor-readable storage medium of clause 31, wherein the application for transfer of the ultra-wideband physical-layer signal is a ranging application or a channel estimation application.

Clause 37. The non-transitory, processor-readable storage medium of clause 31, wherein the ultra-wideband physical-layer signal is a first ultra-wideband physical-layer signal, and wherein the storage medium further comprises processor-readable instructions to cause the processor to:
transmit, to a network entity, a request for a non-ultra-wideband signal;
receive the non-ultra-wideband signal;
measure the non-ultra-wideband signal;
perform time and frequency synchronization based on measurement of the non-ultra-wideband signal; and
perform signal transfer of a second ultra-wideband physical-layer signal based on the time and frequency synchronization.

Clause 38. The non-transitory, processor-readable storage medium of clause 37, wherein the request for the non-ultra-wideband signal includes an explicit request for an on-demand reference signal.

Clause 39. The non-transitory, processor-readable storage medium of clause 38, wherein the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal.

Clause 40. The non-transitory, processor-readable storage medium of clause 37, wherein the request for the non-ultra-wideband signal includes an indication of one or more ultra-wideband channels in which the apparatus is configured for operation. Clause 41. A server comprising:
a transceiver;
a memory; and
a processor, communicatively coupled to the memory and the transceiver, configured to:
   receive, via the transceiver, an indication that a first user equipment is capable of ranging measurements using an ultra-wideband session; and
   transmit, via the transceiver to the first user equipment, a message indicating a sidelink channel for the first user equipment to use for time and frequency synchronization and an ultra-wideband channel for the first user equipment to use for ranging with a second user equipment.

Clause 42. The server of clause 41, wherein the processor is configured to determine the sidelink channel based on the indication indicating the ultra-wideband channel.

Clause 43. The server of clause 41, wherein the processor is configured to transmit, via the transceiver to the first user equipment and the second user equipment, a broadcast out-of-band reference signal for the first user equipment and the second user equipment to use for time and frequency synchronization.

Clause 44. An ultra-wideband ranging assistance method comprising:
receiving an indication that a first user equipment is capable of ranging measurements using an ultra-wideband session; and
transmitting, to the first user equipment, a message indicating a sidelink channel for the first user equipment to use for time and frequency synchronization and an ultra-wideband channel for the first user equipment to use for ranging with a second user equipment.

Clause 45. The ultra-wideband ranging assistance method of clause 44, further comprising determining the sidelink channel based on the indication indicating the ultra-wideband channel.

Clause 46. The ultra-wideband ranging assistance method of clause 44, further comprising transmitting, to the first user equipment and the second user equipment, a broadcast out-of-band reference signal for the first user equipment and the second user equipment to use for time and frequency synchronization.

Clause 47. A server comprising:
means for receiving an indication that a first user equipment is capable of ranging measurements using an ultra-wideband session; and
means for transmitting, to the first user equipment, a message indicating a sidelink channel for the first user equipment to use for time and frequency synchronization and an ultra-wideband channel for the first user equipment to use for ranging with a second user equipment.

Clause 48. The server of clause 47, further comprising means for determining the sidelink channel based on the indication indicating the ultra-wideband channel.

Clause 49. The server of clause 47, further comprising means for transmitting, to the first user equipment and the second user equipment, a broadcast out-of-band reference signal for the first user equipment and the second user equipment to use for time and frequency synchronization.

Clause 50. A non-transitory, processor-readable storage medium comprising processor-readable instructions to cause a processor of a server to:
receive an indication that a first user equipment is capable of ranging measurements using an ultra-wideband session; and
transmit, to the first user equipment, a message indicating a sidelink channel for the first user equipment to use for time and frequency synchronization and an ultra-wideband channel for the first user equipment to use for ranging with a second user equipment.

Clause 51. The non-transitory, processor-readable storage medium of clause 50, further comprising processor-readable instructions to cause the processor to determine the sidelink channel based on the indication indicating the ultra-wideband channel.

Clause 52. The non-transitory, processor-readable storage medium of clause 50, further comprising processor-readable instructions to cause the processor to transmit, to the first user equipment and the second user equipment, a broadcast out-of-band reference signal for the first user equipment and the second user equipment to use for time and frequency synchronization. Clause 53. An apparatus comprising:
a transceiver configured to transmit and receive ultra-wideband signals;
a memory; and
a processor, communicatively coupled to the memory and the transceiver, configured to:
   transmit, via the transceiver, a request for an on-demand non-ultra-wideband signal;
   receive, via the transceiver, the on-demand non-ultra-wideband signal;
   perform time synchronization and frequency synchronization using the on-demand non-ultra-wideband signal; and
   perform ranging using an ultra-wideband physical-layer signal having a corresponding frequency band and an expected timing;
wherein the request for the on-demand non-ultra-wideband signal includes a first indication of a requested frequency of the on-demand non-ultra-wideband signal, wherein the requested frequency is within a threshold frequency of the frequency band of the ultra-wideband physical-layer signal, or includes a second indication of a requested timing of the on-demand non-ultra-wideband signal, wherein the requested timing is within a threshold timing of the expected timing of the ultra-wideband physical-layer signal, or includes a combination thereof.

Clause 54. The apparatus of clause 53, wherein the first indication of the requested frequency indicates the frequency band of the ultra-wideband physical-layer signal.

Clause 55. The apparatus of clause 53, wherein the second indication of the requested timing indicates the expected timing of the ultra-wideband physical-layer signal.

Clause 56. A ranging method comprising:
transmitting, from an apparatus, a request for an on-demand non-ultra-wideband signal;
receiving, at the apparatus, the on-demand non-ultra-wideband signal;
performing, at the apparatus, time synchronization and frequency synchronization using the on-demand non-ultra-wideband signal; and
performing, at the apparatus, ranging using an ultra-wideband physical-layer signal having a corresponding frequency band and an expected timing;
wherein the request for the on-demand non-ultra-wideband signal includes a first indication of a requested frequency of the on-demand non-ultra-wideband signal, wherein the requested frequency is within a threshold frequency of the frequency band of the ultra-wideband physical-layer signal, or includes a second indication of a requested timing of the on-demand non-ultra-wideband signal, wherein the requested timing is within a threshold timing of the expected timing of the ultra-wideband physical-layer signal, or includes a combination thereof.

Clause 57. The ranging method of clause 56, wherein the first indication of the requested frequency indicates the frequency band of the ultra-wideband physical-layer signal.

Clause 58. The ranging method of clause 56, wherein the second indication of the requested timing indicates the expected timing of the ultra-wideband physical-layer signal.

Clause 59. An apparatus comprising:
means for transmitting a request for an on-demand non-ultra-wideband signal;
means for receiving the on-demand non-ultra-wideband signal;
means for performing time synchronization and frequency synchronization using the on-demand non-ultra-wideband signal; and
means for performing ranging using an ultra-wideband physical-layer signal having a corresponding frequency band and an expected timing;
wherein the request for the on-demand non-ultra-wideband signal includes a first indication of a requested frequency of the on-demand non-ultra-wideband signal, wherein the requested frequency is within a threshold frequency of the frequency band of the ultra-wideband physical-layer signal, or includes a second indication of a requested timing of the on-demand non-ultra-wideband signal, wherein the requested timing is within a threshold timing of the expected timing of the ultra-wideband physical-layer signal, or includes a combination thereof.

Clause 60. The apparatus of clause 59, wherein the first indication of the requested frequency indicates the frequency band of the ultra-wideband physical-layer signal.

Clause 61. The apparatus of clause 59, wherein the second indication of the requested timing indicates the expected timing of the ultra-wideband physical-layer signal.

Clause 62. A non-transitory, processor-readable storage medium comprising processor-readable instructions to cause a processor of an apparatus to:
transmit a request for an on-demand non-ultra-wideband signal;
receive the on-demand non-ultra-wideband signal;
perform time synchronization and frequency synchronization using the on-demand non-ultra-wideband signal; and
perform ranging using an ultra-wideband physical-layer signal having a corresponding frequency band and an expected timing;
wherein the request for the on-demand non-ultra-wideband signal includes a first indication of a requested frequency of the on-demand non-ultra-wideband signal, wherein the requested frequency is within a threshold frequency of the frequency band of the ultra-wideband physical-layer signal, or includes a second indication of a requested timing of the on-demand non-ultra-wideband signal, wherein the requested timing is within a threshold timing of the expected timing of the ultra-wideband physical-layer signal, or includes a combination thereof.

Clause 63. The non-transitory, processor-readable storage medium of clause 62, wherein the first indication of the requested frequency indicates the frequency band of the ultra-wideband physical-layer signal.

Clause 64. The non-transitory, processor-readable storage medium of clause 62, wherein the second indication of the requested timing indicates the expected timing of the ultra-wideband physical-layer signal.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that communication using the wireless communication device is exclusively, or evenly primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a transceiver configured to transmit and receive ultra-wideband signals;
a memory; and
a processor, communicatively coupled to the memory and the transceiver, configured to:
determine whether to transmit an ultra-wideband physical-layer signal with a first configuration or a second configuration based on an application for transfer of the ultra-wideband physical-layer signal, the first configuration being different from the second configuration; and
transmit, via the transceiver, the ultra-wideband physical-layer signal.

2. The apparatus of claim 1, wherein the first configuration includes a synchronization preamble and includes a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

3. The apparatus of claim 2, wherein the processor is configured to transmit, via the transceiver, a higher-layer signal, using a protocol layer above a physical layer in a protocol stack, wherein the higher-layer signal indicates whether the apparatus will transmit the ultra-wideband physical-layer signal with the first configuration or the second configuration.

4. The apparatus of claim 1, wherein the processor is configured to transmit, via the transceiver, a higher-layer signal, using a protocol layer above a physical layer in a protocol stack, wherein the higher-layer signal indicates that the apparatus will transmit the ultra-wideband physical-layer signal with the first configuration, wherein the first configuration is based on a non-ranging application for the ultra-wideband physical-layer signal.

5. The apparatus of claim 1, wherein the processor is configured to transmit, via the transceiver, a higher-layer signal, using a protocol layer above a physical layer in a protocol stack, wherein the higher-layer signal indicates whether the apparatus will transmit the ultra-wideband physical-layer signal with:
a synchronization preamble and a physical-layer payload, or a scrambled timestamp sequence preamble, or a combination thereof; or
the synchronization preamble alone; or
the scrambled timestamp sequence preamble alone; or
another sequence.

6. The apparatus of claim 1, wherein the application for transfer of the ultra-wideband physical-layer signal is a ranging application or a channel estimation application.

7. The apparatus of claim 1, wherein the ultra-wideband physical-layer signal is a first ultra-wideband physical-layer signal, and wherein the processor is configured to:
transmit, via the transceiver to a network entity, a request for a non-ultra-wideband signal;
receive the non-ultra-wideband signal;
measure the non-ultra-wideband signal;
perform time and frequency synchronization based on measurement of the non-ultra-wideband signal; and
perform signal transfer of a second ultra-wideband physical-layer signal based on the time and frequency synchronization.

8. The apparatus of claim 7, wherein the request for the non-ultra-wideband signal includes an explicit request for an on-demand reference signal.

9. The apparatus of claim 8, wherein the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal.

10. The apparatus of claim 7, wherein the request for the non-ultra-wideband signal includes an indication of one or more ultra-wideband channels in which the apparatus is configured for operation.

11. A signal transfer method comprising:
determining, at a first apparatus, whether to transmit an ultra-wideband physical-layer signal with a first configuration or a second configuration based on an application for transfer of the ultra-wideband physical-layer signal, the first configuration being different from the second configuration; and
transmitting, from the first apparatus to a second apparatus, the ultra-wideband physical-layer signal.

12. The signal transfer method of claim 11, wherein the first configuration includes a synchronization preamble and a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

13. The signal transfer method of claim 12, further comprising transmitting, from the first apparatus, a higher-layer signal, using a protocol layer above a physical layer in a protocol stack, wherein the higher-layer signal indicates whether the first apparatus will transmit the ultra-wideband physical-layer signal with the first configuration or the second configuration.

14. The signal transfer method of claim 11, further comprising transmitting, from the first apparatus, a higher-layer signal, using a protocol layer above a physical layer in a protocol stack, wherein the higher-layer signal indicates that the first apparatus will transmit the ultra-wideband physical-layer signal with the first configuration, wherein the first configuration is based on a non-ranging application for the ultra-wideband physical-layer signal.

15. The signal transfer method of claim 11, further comprising transmitting, from the first apparatus, a higher-layer signal, using a protocol layer above a physical layer in a protocol stack, wherein the higher-layer signal indicates whether the first apparatus will transmit the ultra-wideband physical-layer signal with:
a synchronization preamble and a frame body, wherein the frame body includes a physical-layer payload, or a scrambled timestamp sequence preamble, or a combination thereof; or
the synchronization preamble alone; or
the scrambled timestamp sequence preamble alone; or
another sequence.

16. The signal transfer method of claim 11, wherein the application for transfer of the ultra-wideband physical-layer signal is a ranging application or a channel estimation application.

17. The signal transfer method of claim 11, wherein the ultra-wideband physical-layer signal is a first ultra-wideband physical-layer signal, and wherein the signal transfer method further comprises:
transmitting, from the first apparatus to a network entity, a request for a non-ultra-wideband signal;
receiving the non-ultra-wideband signal at the first apparatus;
measuring the non-ultra-wideband signal at the first apparatus;
performing, at the first apparatus, time and frequency synchronization based on measurement of the non-ultra-wideband signal; and
performing, at the first apparatus, signal transfer of a second ultra-wideband physical-layer signal based on the time and frequency synchronization.

18. The signal transfer method of claim 17, wherein the request for the non-ultra-wideband signal includes an explicit request for an on-demand reference signal.

19. The signal transfer method of claim 18, wherein the explicit request for the on-demand reference signal indicates a requested frequency within a threshold frequency of a frequency of the second ultra-wideband physical-layer signal and indicates a requested transfer time within a threshold time of a transfer time of the second ultra-wideband physical-layer signal.

20. The signal transfer method of claim 17, wherein the request for the non-ultra-wideband signal includes an indication of one or more ultra-wideband channels in which the first apparatus is configured for operation.

21. An apparatus comprising:
means for determining whether to transmit an ultra-wideband physical-layer signal with a first configuration or a second configuration based on an application for transfer of the ultra-wideband physical-layer signal, the first configuration being different from the second configuration; and
means for transmitting the ultra-wideband physical-layer signal.

22. The apparatus of claim 21, wherein the first configuration includes a synchronization preamble and a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

23. The apparatus of claim 22, further comprising means for transmitting a higher-layer signal, using a protocol layer above a physical layer in a protocol stack, wherein the higher-layer signal indicates whether the apparatus will transmit the ultra-wideband physical-layer signal with the first configuration or the second configuration.

24. The apparatus of claim 21, further comprising means for transmitting a higher-layer signal, using a protocol layer above a physical layer in a protocol stack, wherein the higher-layer signal indicates that the apparatus will transmit the ultra-wideband physical-layer signal with the first configuration, wherein the first configuration is based on a non-ranging application for the ultra-wideband physical-layer signal.

25. The apparatus of claim 21, further comprising means for transmitting a higher-layer signal, using a protocol layer above a physical layer in a protocol stack, wherein the higher-layer signal indicates whether the apparatus will transmit the ultra-wideband physical-layer signal with:
a synchronization preamble and a physical-layer payload, or a scrambled timestamp sequence preamble, or a combination thereof; or
the synchronization preamble alone; or
the scrambled timestamp sequence preamble alone; or
another sequence.

26. A non-transitory, processor-readable storage medium comprising processor-readable instructions to cause a processor of an apparatus to:
determine whether to transmit an ultra-wideband physical-layer signal with a first configuration or a second configuration based on an application for transfer of the ultra-wideband physical-layer signal, the first configuration being different from the second configuration; and
transmit the ultra-wideband physical-layer signal.

27. The non-transitory, processor-readable storage medium of claim 26, wherein the first configuration includes a synchronization preamble and a physical-layer payload, or a scrambled timestamp sequence preamble, or a combination thereof, and wherein the second configuration includes the synchronization preamble without the scrambled timestamp sequence preamble, or the scrambled timestamp sequence preamble without the synchronization preamble.

28. The non-transitory, processor-readable storage medium of claim 27, further comprising processor-readable instructions to cause the processor to transmit a higher-layer signal, using a protocol layer above a physical layer in a protocol stack, wherein the higher-layer signal indicates whether the apparatus will transmit the ultra-wideband physical-layer signal with the first configuration or the second configuration.

29. The non-transitory, processor-readable storage medium of claim 26, further comprising processor-readable instructions to cause the processor to transmit a higher-layer signal, using a protocol layer above a physical layer in a protocol stack, wherein the higher-layer signal indicates that the apparatus will transmit the ultra-wideband physical-layer signal with the first configuration, wherein the first configuration is based on a non-ranging application for the ultra-wideband physical-layer signal.

30. The non-transitory, processor-readable storage medium of claim 26, further comprising processor-readable instructions to cause the processor to transmit a higher-layer signal, using a protocol layer above a physical layer in a protocol stack, wherein the higher-layer signal indicates whether the apparatus will transmit the ultra-wideband physical-layer signal with:
a synchronization preamble and a physical-layer payload, or a scrambled timestamp sequence preamble, or a combination thereof; or
the synchronization preamble alone; or
the scrambled timestamp sequence preamble alone; or
another sequence.
